(19) United States
(12) Patent Application Publication
(10) Pub. No.: US 2007/0244797 A1
(43) Pub. Date: Oct. 18, 2007

(54) COMPUTER NETWORK-IMPLEMENTED SYSTEM AND METHOD FOR VEHICLE TRANSACTIONS

(76) Inventors: W. Bryant Hinson, Tucker, GA (US); James Anderson, Tucker, GA (US); William Aydlotte, Tucker, GA (US); Ross McClellan, Atlanta, GA (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 11/689,023

(22) Filed: Mar. 21, 2007

Related U.S. Application Data
(60) Provisional application No. 60/784,722, filed on Mar. 22, 2006.

(51) Int. Cl. G06Q 40/00

(52) U.S. Cl. 705/37

(57) ABSTRACT

A system and method for performing vehicle transactions via a reverse auction website includes a server for receiving a customer request for bids on a specified vehicle. The server is communicatively coupled to a plurality of customer user devices and a plurality of dealer user devices. The server transmits the customer request to a plurality of dealers who then provide bids for the specified vehicle. The system publishes the bids to the customer and to all bidding dealers so that the dealers have the opportunity to view other dealers' bids and, based on this, revise their bids accordingly. When the reverse auction ends, the customer can select one of the dealer's bids.

### CROSS-REFERENCE TO RELATED APPLICATION

This application claims the priority benefit of U.S. Provisional Patent Application Ser. No. 60/784,722, filed Mar. 22, 2006, the entire scope and content of which is hereby incorporated herein by reference.

### TECHNICAL FIELD

The present invention relates generally to vehicle sales, and in particular, to a computer network-implemented system and method for vehicle sales transactions.

### BACKGROUND OF THE INVENTION

Purchasing a new car traditionally has been a very unpleasant experience that is dreaded by most buyers. Most people particularly dislike dealing with car salespeople because they usually feel pressured and manipulated by them. Even after spending a lot of time hassling with the salespeople, visiting different dealers, checking newspaper advertisements, etc., it still can be difficult for the purchaser to tell if he or she is getting a good deal.

In an effort to provide more convenience to buyers and in turn attract more buyers, many dealerships have Internet websites with photographs and other information on cars they have in inventory. There are also numerous car sales websites such as “vehix.com” and “edmunds.com.” But these websites are really just referral sites where buyers specify details of the car they want and enter their contact information, which is then forwarded to salespeople at local dealerships who contact the buyers.

In addition, one website, namely “mycar.com,” existed that purported to provide an auction with car dealers competing for the buyers' business (but it is believed that this website no longer is in operation). In reality, though, this system was not really an auction because the car bid prices were pre-quoted by the dealers. So the dealers were not really bidding against each other on a case-by-case basis in the manner of a traditional auction. The dealers could not see what the other dealers had bid, and they did not have the opportunity to lower their bid to win a particular sale. Instead, every buyer who specified a particular car in a particular area received the same pre-arranged price quotes from the same dealers. So buyers really couldn't tell if they had gotten the best price possible. Essentially, this was really just another referral site, with the dealers paying a fee for each referral. And after making a decision to purchase, the buyer still had to negotiate out all the small details with the dealer.

Accordingly, it can be seen that a need exists for a better way to buy a car. In particular, there are needs for improved on-line car-buying systems that provide customers a no-hassle buying experience that assures they get a good price, and that provide dealers with a low-cost, low-risk way to expand their sales channels, reduce their cost of sales, and focus on qualified buyers. It is to such solutions that the present invention is primarily directed.

### SUMMARY OF THE INVENTION

Generally described, the present invention provides a system for vehicle transactions between a customer and a selected one of a plurality of dealers. The system includes a server connected to a communications network and having access to a vehicle specifications database. The server hosts a website that is accessible by network-connected user devices of the customer and the dealers, wherein the website provides for a reverse auction in which the dealers bid against each other in a true reverse auction process to win the business of the customer. The server further hosts separate accounts for each of the plurality of dealers and for each customer. For example, each dealer and each customer can have access to its own dedicated website for monitoring the reverse auction. In this way, the vehicle salesperson is removed from the process, resulting in a hassle-free, pressure-free experience for the customer.

In an example embodiment, the present invention includes a method of transacting vehicles between a customer and a selected one of a plurality of dealers. The method includes the steps of receiving a request from the customer for a specified vehicle; communicating the bid request to each of the plurality of dealers; receiving bids from the plurality of dealers; communicating all of the dealer bids to the customer and to the plurality of dealers; receiving revised bids from the plurality of dealers; and receiving from the customer a selection of one of the bids or revised bids from one of the plurality of dealers. Preferably, the dealers are located near the customer. If a predetermined number of bids is not received within a preset amount of time, the method further includes the step of sending bid requests to a supplemental plurality of dealers. The supplemental plurality of dealers can be located farther away from the customer. Bids are received for the specified vehicle, as well as for similar vehicles. Bids preferably include all fees and taxes the customer is expected to pay. Also preferably, the identities of the customer and the dealers are not accessible to each other until after the close of the auction. Also preferably, payment from the customer is received prior to communicating the customer request to the plurality of dealers.

In another aspect, the present invention includes a method for conducting a reverse auction. The method includes the steps of electronically requesting bids from a plurality of bidders for a specified vehicle; electronically receiving bids from the plurality of bidders; and electronically publishing all received bids to all bidders via a website. Preferably, the bids are published as they are received. The method can further include the steps of electronically communicating to a first bidder a message that it has been outbid by a second bidder, receiving a revised bid from the first bidder, and prompting the purchaser to accept a bid.

In another aspect, the present invention includes a computer-readable medium storing instructions that, when executed on a programmed processor, carry out a method for a reverse auction for a vehicle. The stored instructions include instructions for processing a request for a specified vehicle; instructions for soliciting bids from a plurality of bidders for the specified vehicle; instructions for receiving bids from the plurality of bidders; and instructions for publishing all received bids to all bidders via a website. The computer-readable medium can further store instructions for processing an acceptance of a bid and instructions for filtering frivolous requests by requiring an auction fee payment prior to soliciting bids from the plurality of bidders.

The specific techniques and structures employed by the invention to improve over the drawbacks of the prior devices and accomplish the advantages described herein will become apparent from the following detailed description of the example embodiments of the invention and the appended drawings and claims.

### BRIEF DESCRIPTION OF THE DRAWINGS

FIG. 1 is a functional block diagram illustrating a system architecture for conducting a reverse auction for a vehicle according to an example embodiment of the present invention.

FIG. 2 is a flow diagram of a process for registering a dealer's account on the system of FIG. 1 according to an example embodiment of the present invention.

FIG. 3 is an example screenshot of a registered dealer's dedicated webpage created by the system of FIG. 1.

FIGS. 4A and 4B are a flow diagram of a process executed when the system of FIG. 1 receives a customer's request for a reverse auction according to an example embodiment of the present invention.

FIGS. 5A and 5B are a flow diagram of a process for conducting a reverse auction via the system of FIG. 1 according to an example embodiment of the present invention.

FIG. 6 is an example screenshot of a dealer's dedicated webpage displayed by the system of FIG. 1 and showing a listing of competing bids.

FIG. 7 is an example screenshot of information the system of FIG. 1 prompts the dealer to complete in order to submit a bid.

FIG. 8 is an example screenshot of a customer's dedicated webpage displayed by the system of FIG. 1 and showing a listing of received bids.

FIG. 9 is an example screenshot of a detailed bid linked to the customer's dedicated webpage of FIG. 8.

FIG. 10 is a flow diagram of a process the system of FIG. 1 follows after bidding has closed according to an example embodiment of the present invention.

FIG. 11 is an example screenshot of a reservation for a vehicle to be purchased as displayed to the customer by the system of FIG. 1.

### DESCRIPTION OF EXAMPLE EMBODIMENTS OF THE INVENTION

Generally described, the present invention provides a system and method for conducting a reverse auction in which vehicle dealers bid against each other to win the business of vehicle-buying customers. The customer is presented with a transparent interactive bidding process where multiple dealers offer prices for the specified vehicle to the customer, as opposed to simply providing a price quote from a local dealer (the way other car-buying websites operate). This creates a “win-win” proposition for the customers and the dealers, for example, by efficiently shifting what would have been a fixed cost (i.e. a dealership sales position) to a variable cost (i.e. success fee), and by ensuring that the customers get the best price without the typical car-buying hassles.

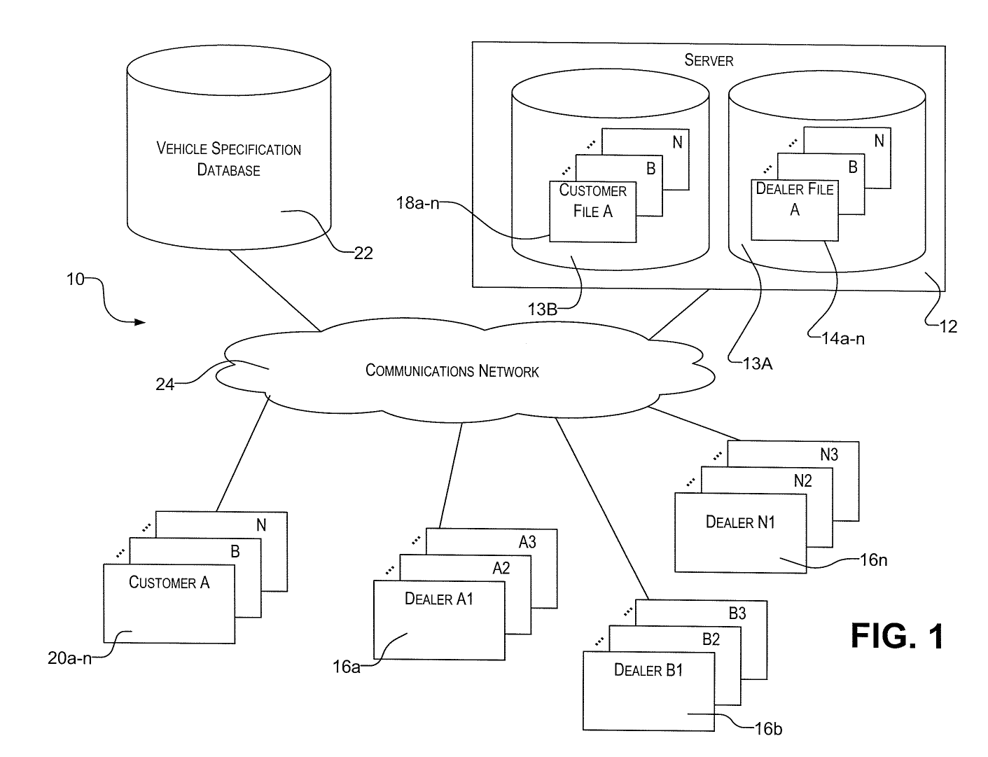

Referring to the drawings figures, FIG. 1 is a functional block diagram illustrating the system architecture of such a system 10 according to an example embodiment of the present invention. The system 10 includes a server 12 with a computer processor and at least one computer-readable storage medium 13A and 13B (collectively, “the storage devices 13”) such as a hard drive, a CD-ROM disc or other medium for an optic drive, and/or a magnetic tape, disc, or other medium for such a drive. Two such data storage devices are depicted in FIG. 1. A first storage medium 13A stores dealer files 14a-n for one or more vehicle dealerships each having one or more retail locations or dealer lots. The dealerships can be a corporate group of dealerships in the area. The dealer files 14a-n include contact information, a listing of makes and models sold by the dealer, etc. for each corporate group of participating dealerships and each of the dealer lots. In addition, a second storage medium 13B stores customer files 18a-n for a plurality of customers who are in the market for a new car, truck, van, or other motorized vehicle, such as but not limited to, boats, motorcycles, ATV's and motor homes. The customer files 18a-n include the customer's contact information, payment information, vehicle information for the specified vehicle to be purchased, and login information (such as username and password) for each of the customers 20a-n who uses the system 10. Alternatively, the dealer files 14a-n and the customer files 16a-n can be stored on a single storage medium or on multiple storage media.

Furthermore, the system 10 includes a database 22 of vehicle specification information, including makes and available models, packages, options, and colors. Such information can be stored in tables or structured files in the database 22, which are generally well known in the art. The database 22 is accessible as a subscription service accessible via the Internet (as depicted) or as a component stored on the server 12. For example, the database 22 can be of the type provided by JATO DYNAMICS of the United Kingdom. The vehicle specifications database 22 can automatically be updated as new vehicles and options become available.

The server 12 communicates with user devices 16a-n of the dealers, user devices 20a-n of the customers, and the database 22 via a communications network 24. The communications network 24 is preferably a global computer network such as the Internet, and the system 10 is preferably implemented as an application service provided on the Internet. In this typical commercial embodiment, the server 12 is a bank of computer servers with a scalable architecture that is remotely located relative to the user devices 16a-n of the dealers and to the user devices 20a-n of the customers. The user devices 16a-n of the dealers and the user devices 20a-n of the customers can be desktop computers, laptop computers, hand-held computers, PDA's, web-enabled phones, or other communication devices connected to the network. In alternative embodiments, the communications network 24 is provided by a wireless cellular network or another computer-based network. It will be understood that the system 10 can be readily adapted for conducting reverse auctions of goods and/or services other than vehicles.

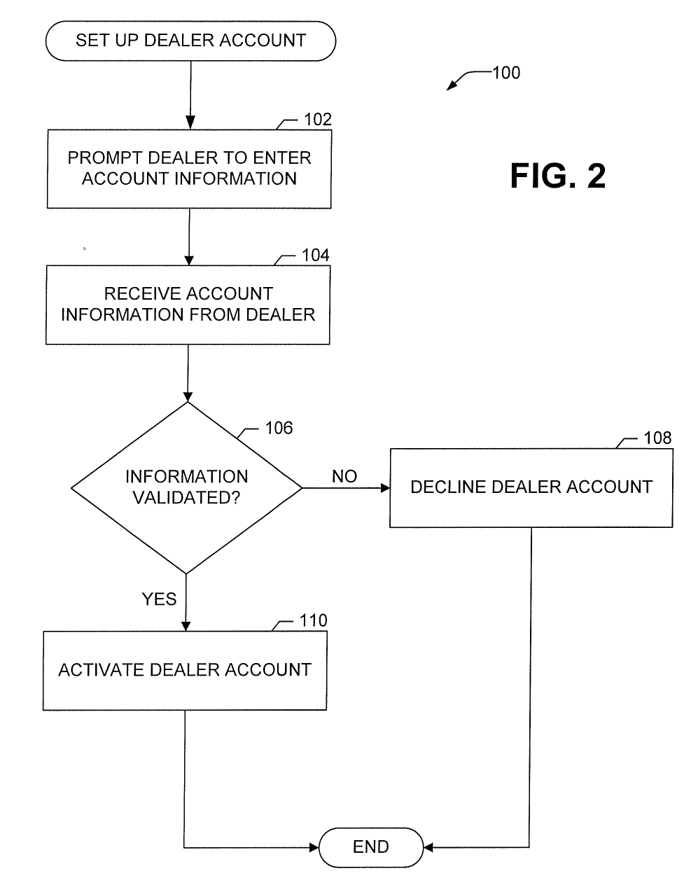

FIG. 2 depicts a flow diagram of a process 100 by which the server 12 of the system 10 registers a dealer account on the server 12. Starting at step 102, the server 12 prompts the dealer or its authorized agent to enter its account information. Such dealer account information can include dealer contact information, a listing of makes and models sold by the dealer, etc. At step 104, the server 12 receives the dealer account information input by the dealer or its authorized agent. At step 106, the server 12 makes a determination as to whether or not the dealer information can be validated. For example, the server 12 will decline a dealer account at step 108 if it cannot verify that the dealership exists or if cannot verify the identity of the person attempting to set up the account, and the process 100 ends. If the server 12 determines at step 106 that the account information is valid, the server activates the dealer account at step 110 and the process 100 ends. In a typical commercial embodiment, the dealers pay no referral fees, no management fees, no maintenance fees, and no membership fees for use of the computer-implemented system of the present invention.

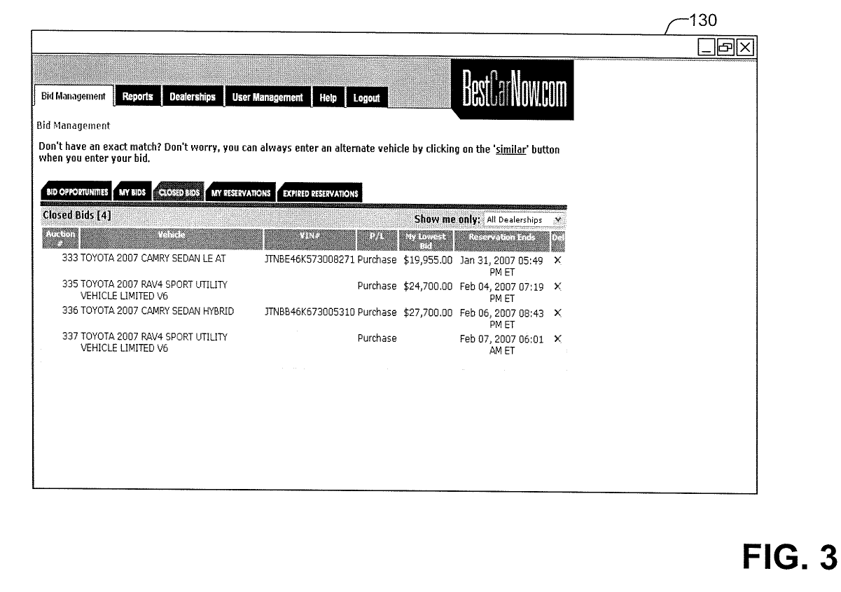

Once the dealership has registered and established an account, the server 12 provides the dealership with its own dedicated page on the website. As used herein and in a typical commercial embodiment, the dedicated page on the website preferably includes multiple web pages (or a “website within a website”) that are linked together (such as tabbed pages behind one another) as illustrated in the figures and as generally well known in the art. An exemplary screenshot 130 of a dealer's dedicated main page is depicted in FIG. 3. As can be seen in this figure, the dealer can follow all of the auctions that it is currently participating in. The dealer can see if it is winning or losing, and by how much. The dealer can monitor the times that the auctions end and can view the final price of the bid that was accepted by the customer, regardless of which dealer “won” the auction. Moreover, each dealer can run any number of reports relating to its use of the system 10 and method of the present invention. Typical dealer reports include reports on the number of auctions in which the dealer bid, the number of auctions the dealer won, the number of auctions the dealer lost, details of each of the auctions won and lost, etc.

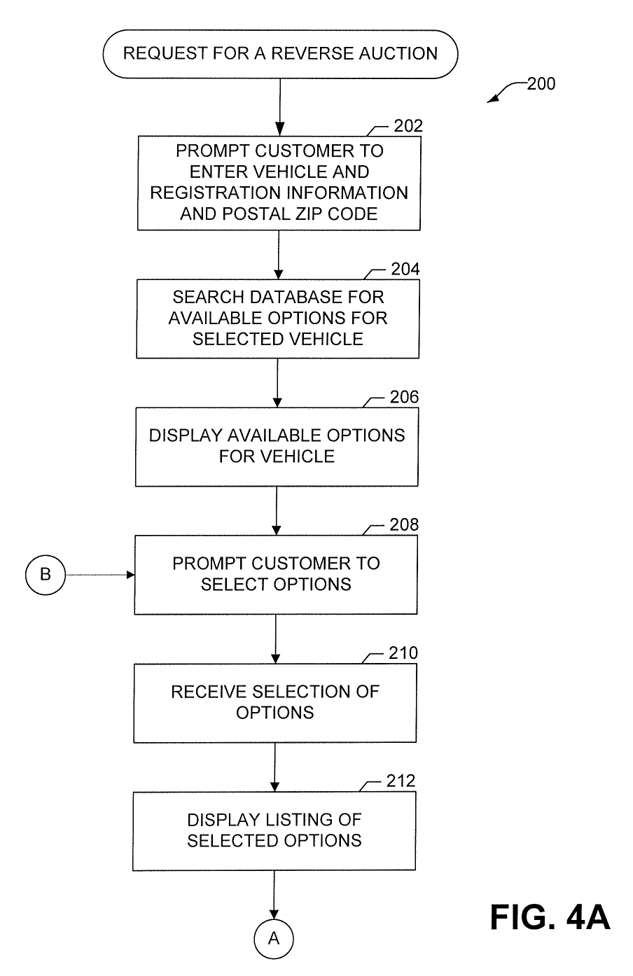

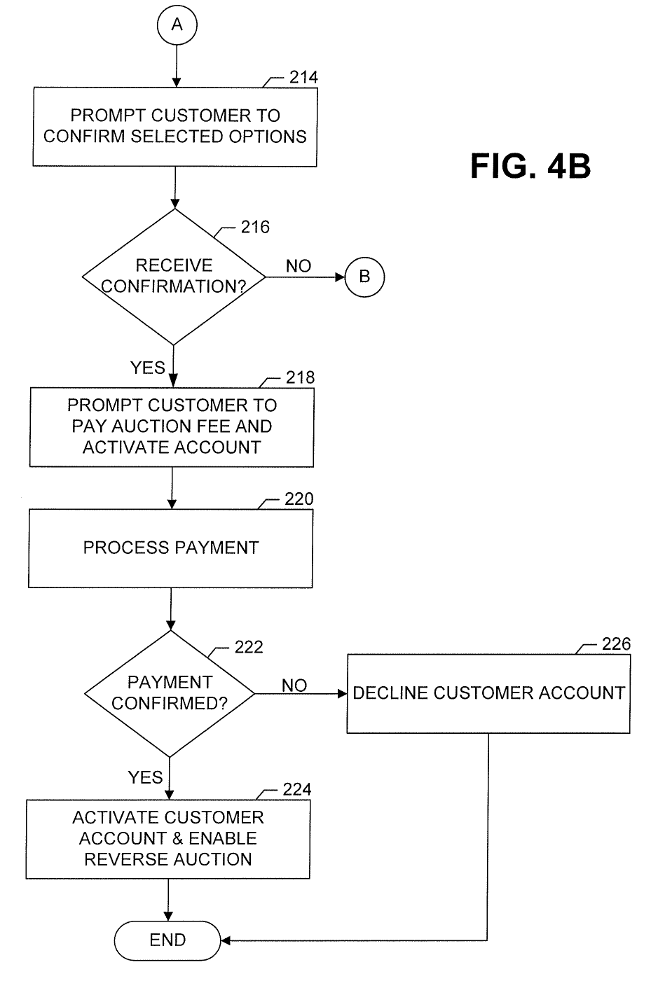

FIGS. 4A and 4B depict a flow diagram of a process 200 executed when the server 12 receives a customer's request for a reverse auction. Beginning at step 202, the server 12 receives a request from a customer wishing to purchase a specified vehicle. Typically, the request is received via the reverse auction website, through which the customer inputs his or her request. The server 12 prompts the customer to enter vehicle and registration information, as well as the customer's postal zip code (or other location indicator). Preferably, vehicle information includes the year, make and model of the specified vehicle for purchase. The server 12 can display drop down menus on the webpage through which the customer can make selections. Registration information can include the city and/or county where the vehicle will be registered. Such registration information allows the dealers to calculate the taxes and registration fees so that the dealers can provide a turnkey price, which includes all fees that the customer will be expected to pay. The server 12 requests a postal zip code so that it can locate dealers in the vicinity of the customer. For example, the dealers can be limited to those located within 50 or 100 miles of the customer. Preferably, the dealers are located within 25 miles of the customer. More preferably, the dealers are located within 15 miles of the customer. Alternatively, the server 12 can prompt the customer to enter, or to select from a menu, the distance that he or she is willing to drive to pick up the vehicle. Optionally, the server 12 can prompt the customer to input whether he wishes to purchase a vehicle or lease a vehicle.

At step 204, the server 12 searches the vehicle specification database 22 for the selected vehicle. The server 12 retrieves the available options from the vehicle specification database 22 for the specified make and model of vehicle and displays them on the screen of the customer's user device 20a at step 206. Options can include, but are not limited to, the exterior color, interior color, leather or cloth interior, number of airbags, sunroof, moon roof, wheel size, CD player, keyless entry, and any other optional vehicle feature. Additionally or alternatively, a package of options may be offered, which is typically provided by the vehicle manufacturer. The server 12 can also retrieve a picture of the vehicle to display to the customer. The picture can be dynamically updated as options are selected. For example, if the customer selects the exterior color to be red, the vehicle in the picture turns red. Such technology is generally well known in the art. At step 208, the server 12 prompts the customer to select the desired options. For example, the server 12 can display check boxes or buttons for available options on the website that the customer can select and submit. In one embodiment, the server 12 depicts all of the available options on a single webpage. Alternatively, the server 12 can prompt the customer to input certain options on a first screen and then enter additional options on different screens. Such approach can be beneficial when certain options are only available when other options are selected. For example, leather interiors may be available only when higher and/or more expensive packages are selected.

Proceeding to step 210, the server 12 receives the selected options, and at step 212, displays a listing of the selected options to the customer. At this point, the customer can review the displayed selected options to ensure that all of the desired options have been selected and that no undesired options have been inadvertently selected. At step 214, the server 12 determines if it has received confirmation of the selected options. If it does not receive confirmation, such as when the customer realizes that extraneous options are listed or that options are missing and selects a button to go back and reselect the options, the server 12 goes back to step 208 and prompts the customer to select the desired options, and repeats steps 212 through 216. Alternatively, the server 12 can send to the customer a confirmation email message, which includes a link to confirm the selected options or a reply address to which the customer can send a confirmation. If at step 216, the server 12 determines that it has received confirmation from the customer, such as when the customer selects a confirm button, the process proceeds to step 218, where it prompts the customer to pay the fee for conducting the reverse auction and activate his or her account. Preferably, the fee is refundable if the customer closes a deal with one of the bidding dealers. Also preferably, the auction fee is large enough to deter frivolous requests by those having no intention of closing a deal but small enough to attract serious buyers. For example, the auction fee can be preset to between $100 and $200, although in other embodiments, the auction fee can preset to be less than $100 or more than $200. In a typical commercial embodiment, the auction fee is $129. The server 12 can prompt the customer to enter his or her credit card information into requested fields. Alternatively, the server 12 can prompt the customer to provide his or her bank account information such that auction fee is debited from his or her bank account. In addition, the server 12 prompts the customer to enter a unique username and password. Optionally, the server 12 can prompt the customer to enter contact information. The username can be the customer's email address or any other unique identifier. The username and password allows a customer to log into his or her account, view his or her dedicated webpage, and monitor the reverse auction on the dedicated webpage.

At step 220, the server 12 processes the payment and at step 222, the server 12 determines if payment has been confirmed. If payment is confirmed, the server 12 then creates a personal account and a dedicated webpage for the customer at step 224 and the reverse auction is enabled. The process 200 of requesting a reverse auctions ends, and a process 300 of conducting a reverse auction begins. If, however, the server 12 determines that payment has not been successfully received, such as when a credit card is declined, the server denies the customer's request for the reverse auction at step 226 and the process 200 ends.

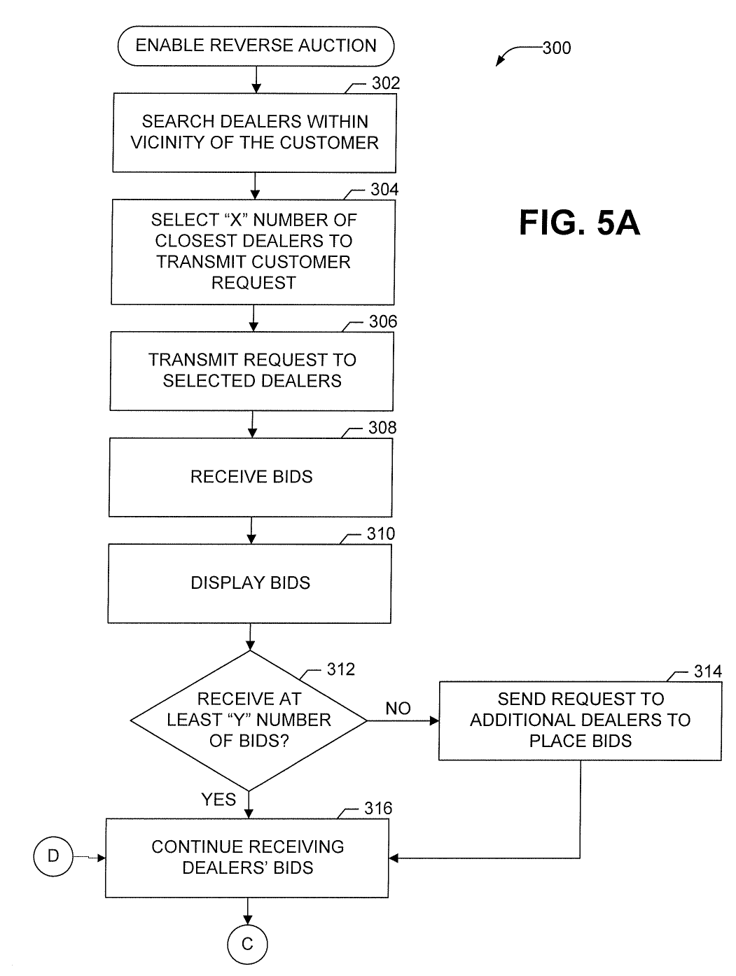

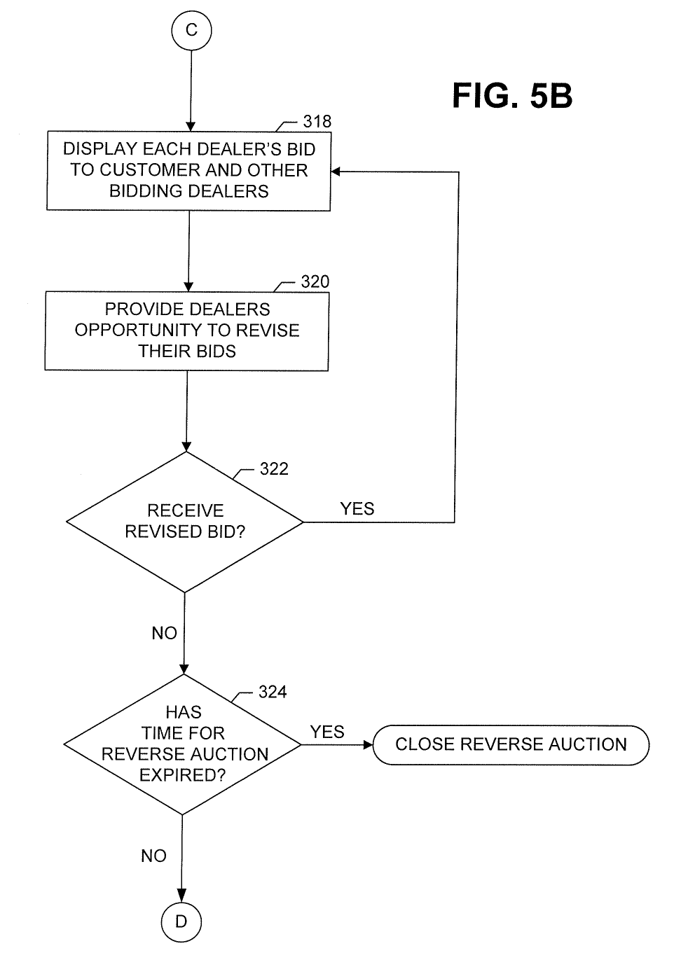

FIGS. 5A and 5B depict a flow diagram of the process 300 for conducting a reverse auction via the computer-implemented system 10 of the present invention. Beginning at step 302, the server 12 searches for registered dealers (according to the dealer registration method 100) within the vicinity of the customer. As discussed above, such vicinity can be selected by the customer or it can be selected by the server 12 (such as by locating dealers as within “M” miles of the customer's postal zip code). Alternatively, the server 12 figuratively can draw a “circle” around the customer, by using the customer's postal zip code, to include a predetermined minimum of nearby dealers, for example, a minimum of four nearby dealers. At step 304, the server 12 selects “X” number of dealers to transmit the customer's request for a reverse action. At least two dealers are selected. Preferably, at least three or more dealers are selected. More preferably, at least four or more dealers are selected. At step 306, the server 12 electronically transmits the customer's request to the selected dealers and invites the dealers to participate in the reverse auction. Such transmission can be in the form of an email or other message, such as an SMS message. The message also preferably includes the time at which the bidding closes. For example, forty-eight hours to ninety-six hours is generally sufficient. In a typical commercial embodiment, the server 12 is preset so that bidding closes after seventy-two hours. Alternatively, such transmission can be a posting to the dealer's dedicated page on the website. Preferably, the server 12 does not transmit the customer's identity; rather, an anonymous request is sent.

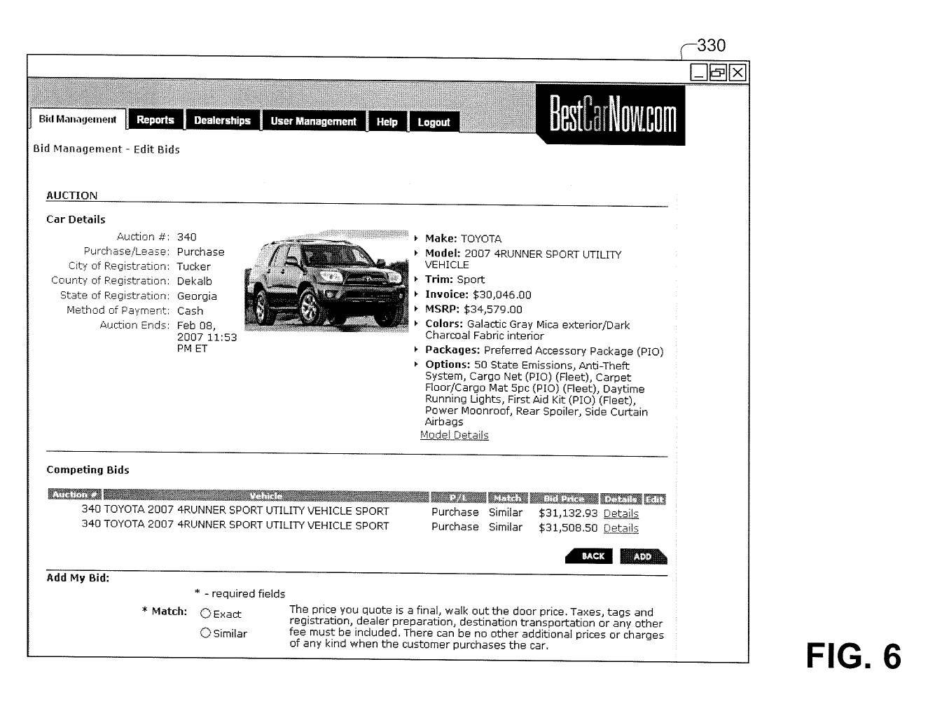

The server 12 receives bids at step 308 and displays the received bids at step 310 to the customer and to each of the bidding dealers. The received bids include bids that match the specified vehicle request exactly, as well as bids for vehicles that don't match all of the vehicle specifications. In a typical commercial embodiment, the server 12 displays an example screenshot 330, as shown in FIG. 6, to the dealer. As shown, the server 12 displays to the dealer a list of the competing bids. The server 12 can display the details of the competing bids to the dealer upon the dealer's request. The server 12 provides the dealer the option of submitting a bid for the exact specified vehicle or for a similar vehicle. For example, a similar match could include a different color, different options, etc. Or if the dealer has a slow-moving inventory item, it could enter a bid for one (or more) of those items as a similar match, in addition to or as an alternative to an exact match bid. Preferably, each bid for a similar match is accompanied by a complete vehicle specification as provided by the dealer, as well as an itemized listing of the charges and credits.

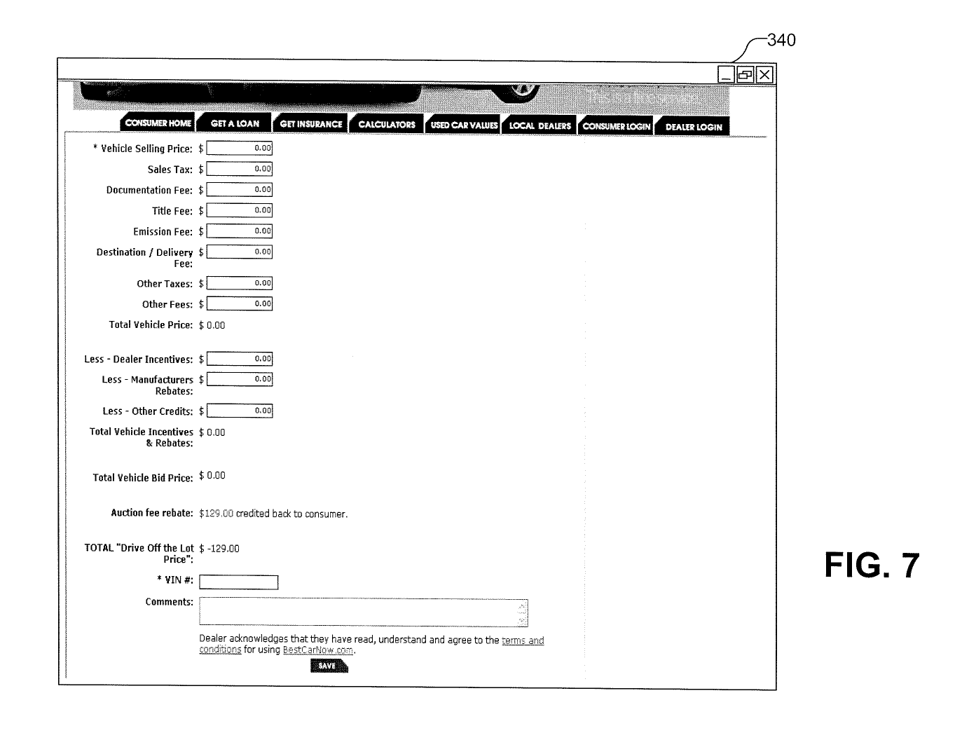

Upon receipt of an input by the dealer that he would like to place a bid, the server 12 displays to the dealer a screen showing a listing of fields for the dealer to complete in order to submit a bid. The listing of fields, as shown in the example screenshot 340 of FIG. 7, can include all fees and credits used to determine the turnkey price. Preferably, each bid is a turnkey price including the vehicle selling price, sales tax, documentation fee, title fee, emission fee, destination/delivery fee, other taxes, and other fees. The details further include credits, such as but not limited to, dealer incentives, dealer manufacturers rebates, the refund of the auction fee, and any other credits. As the auction fee is ultimately credited back to the customer if he or she closes a deal with one of the bidding dealers, the purchasing customer would pay nothing for use of the reverse auction service.

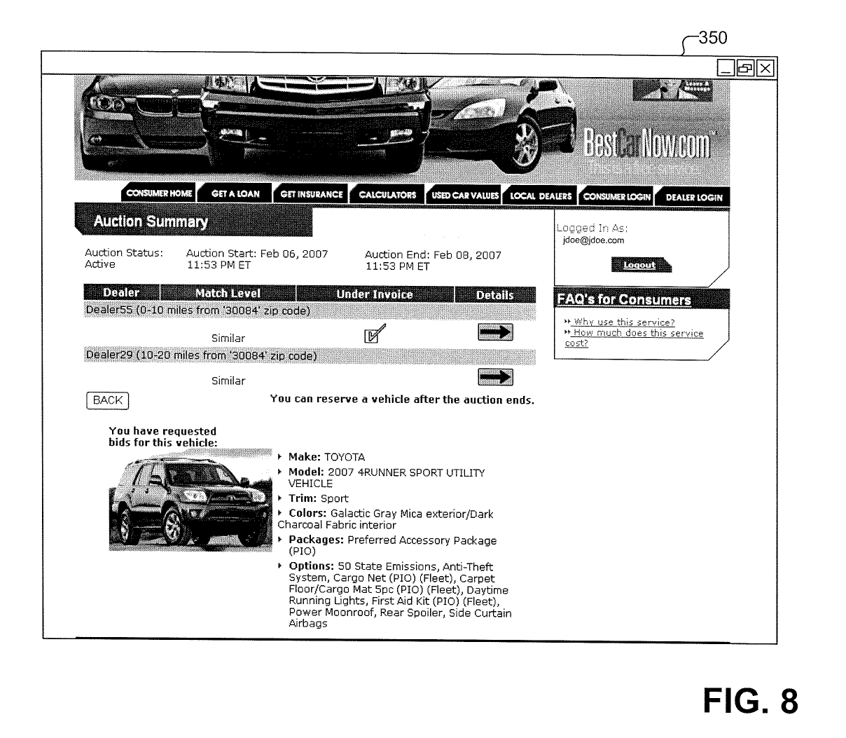

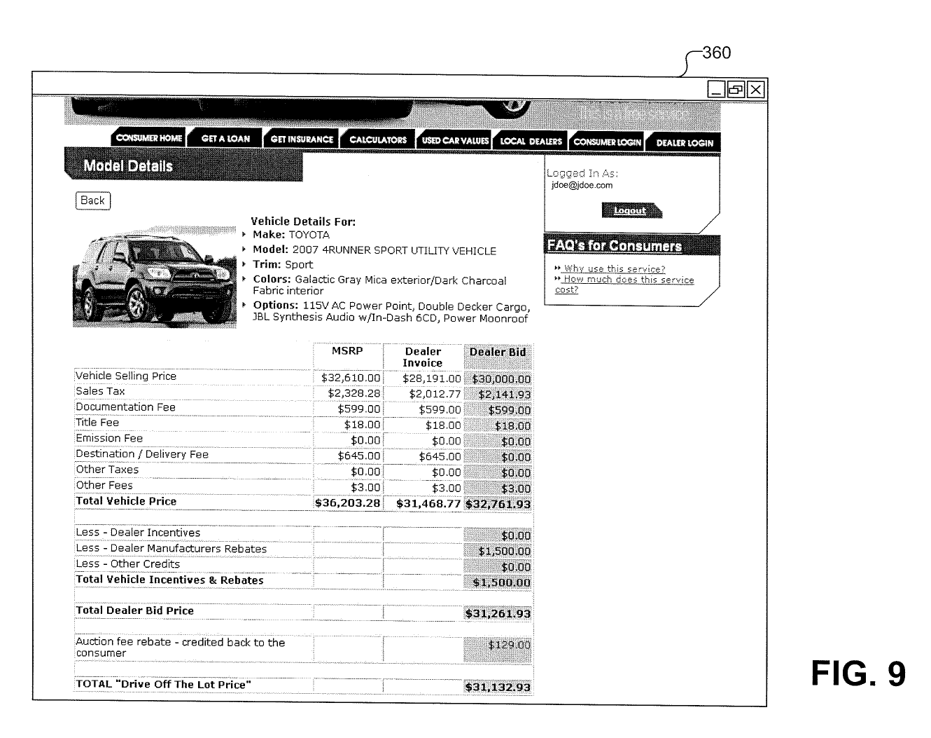

As bids are received, the server 12 displays the bids on the customer's dedicated page of the reverse auction website, as well as on all of the selected dealers' dedicated pages on the reverse auction website. FIG. 8 depicts an example screenshot 350 of a customer's dedicated webpage and showing a listing of received bids. The customer can click on one of the bids to see the details of the bid. FIG. 9 depicts an example screenshot 360 of one dealer's detailed bid as displayed to the customer. Also preferably, the server 12 displays a complete specification for the offered car as provided by the dealer.

After a predetermined amount of time has passed, the server 12 determines at step 312 if it has received at least “Y” number of bid requests within an initial predetermined period of time. The minimum number of bids can be at set at four, for example, although in other embodiments, the minimum number of bids can greater than or less than four. In a typical commercial embodiment, the predetermined amount of time is approximately twenty-four hours; however the duration may be shorter or longer in other embodiments. Preferably, the duration is long enough to give the dealers time to prepare their bids, but not so long as to delay the process of the reverse auction. Generally, a duration set in the range of twelve to forty-eight hours is sufficient. If the server 12 determines that at least “Y” number of bids has not been received at step 312, the server expands its search for dealers and will send dealers outside of the predetermined vicinity a supplemental request to place a bid at step 314. Ideally, all dealers would submit a bid; however, since that is not always feasible, the server 12 attempts to provide the customer with at least two competing bids. Preferably, the server 12 attempts to provide the customer with at least three competing bids. More preferably, the server 12 attempts to provide the customer with at least four competing bids. Thus, when dealers do not bid early, then more dealers will be included in the competition.

If the server 12 determines at step 312 that at least “Y” number of bids has been received, the process proceeds to step 316, where it continues to receive dealers' bids and displays such bids to the customer and to the other bidding dealers at step 318. Preferably, the server 12 displays the bids anonymously to the customer and to the other bidding dealers so that the customer does not know the identity of the dealers, and the dealers do not the identity of each other or of the customer. In an alternative embodiment, the server 12 publishes the identities of the dealers along with their bids to the customer and other bidding dealers. Optionally, the server 12 can send a warning communication (such as an email or SMS message) to a dealer when the dealer has been outbid.

Optionally, the customer bid request can include a request for a bid on a trade-in vehicle. For example, in the customer's request, the server 12 can prompt the customer to enter the vehicle information of the car he or she desires to trade in. Such information could include, the make, model, and year of the vehicle, the mileage, and the condition of the vehicle (such as excellent, good, average, fair, and poor). Thus, the dealers can include the trade-in value in its bid. Preferably, to account for trade-ins, the server 12 displays a webpage to the customer that includes a link to a website with trade-in values, for example, NADA trade-in values. Also optionally, each bid by each of the plurality of dealers can be accompanied by a financing scenario.

At step 320 of FIG. 5B, the server 12 provides dealers the opportunity to revise their bids. Through the dedicated webpage provided by the server, the bidding dealers can log onto the reverse auction website and check on the status of the bidding, see what other dealers have bid, and revise their bid accordingly. For example, in order to “win” the auction, the dealer may be able to provide a lower bid price that beats the two other bids shown in the “Competing Bids” section of the webpage of FIG. 6 by revising the bid details currently entered in the webpage of FIG. 7. By allowing the dealers and the customer to continually monitor the auction on a system website, the customer can receive the benefit of the dealers competing for his or her business. Thus, the system 10 provides a dynamic bidding process so that the customer can get the best price possible. Preferably, the server 12 continuously displays to the customer all of the bids, not just the lowest. Thus, the process resembles a real-life auction. The customer can compare each price/specification bid to the other bids as well as to any other quotes the customer has been given (e.g., via the internet, dealer visits, or advertising). But the bidding dealer's identities have not been displayed or otherwise revealed by the server 12 to the customer. As the server 12 receives revised bids at step 322, it goes back to step 318 and electronically communicates or publishes the bids to the customer and the other bidding dealers. Dealers continue to have the opportunity to submit, revise, or even withdraw their bids up until the server 12 determines at step 324 that the time for the reverse auction has expired. At this point the reverse auction closes and the process 300 for enabling the reverse auction ends.

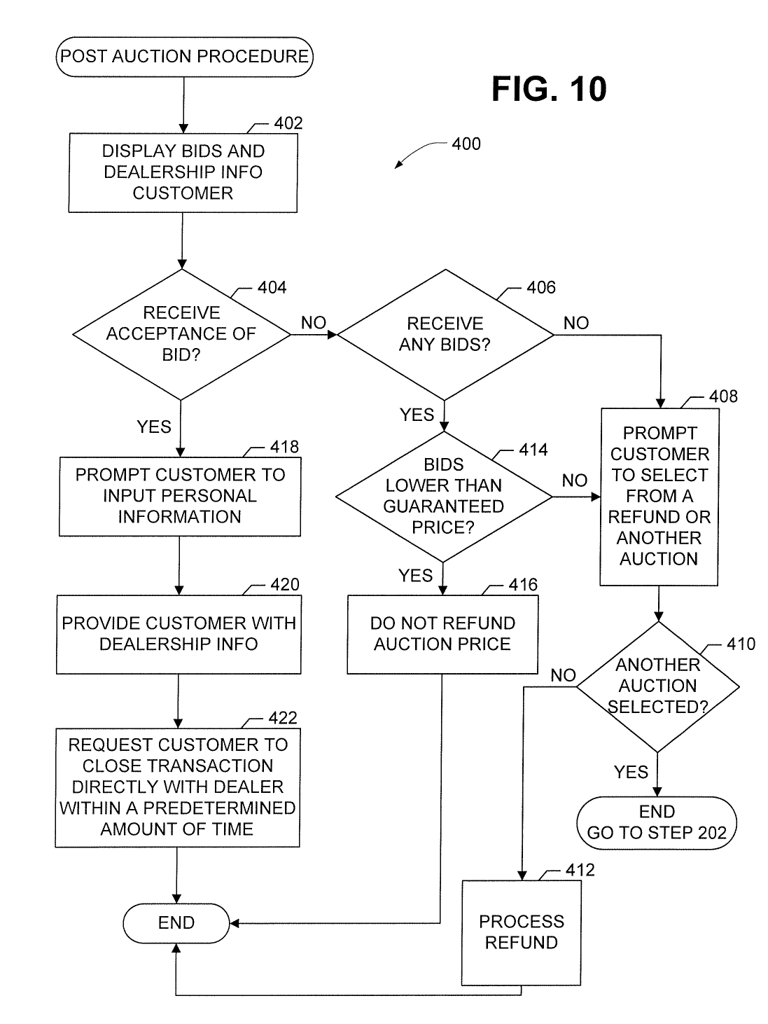

FIG. 10 depicts a flow diagram of a process 400 that occurs after the reverse auction closes. At step 402, the server 12 electronically communicates all final bids, as well as the dealership information, to the customer. At this point, the server 12 allows the customer a predetermined period of time to review the bids and decide which, if any, to accept. For example, the server 12 may provide the customer forty-eight hours to accept a bid. Such period of time is typically preset within a range of about six hours to about seventy-two hours. The customer may base his or her selection on price, but also could be base the selection on the dealer's location, service reputation, etc.

If after the preset amount of time lapses, the server 12 determines that it has not received an acceptance of a bid from the customer at step 404, the process 400 proceeds to step 406 to determine if any bids were received. If no bids were received (or if less than “Y” or another predetermined number of minimum bids were received), then the server 12 prompts the customer to select either a refund of the auction fee or the opportunity to start a new auction for no extra cost at step 408. The server 12 makes a determination at step 410 if it received a selection from the customer to start a new auction. If the server 12 determines that a new auction is selected, the post auction process 400 ends and the server 12 goes to step 202 of the method 200 of requesting a reverse auction (of FIG. 4A). If, however, the server 12 determines that a new auction was not selected but rather a refund has been selected, the server 12 processes the refund request at step 412 by applying a credit in the amount of the auction fee to the customer's credit card (or bank account). The post-auction process 400 then ends.

Referring back to the determination step 406, if the server 12 determines that bids were received, but the customer did not select one, then the method 400 proceeds to step 414 to determine if the received bids were lower than a “guaranteed price.” The “guaranteed price” is generally a predetermined amount of money or a percentage off of the MSRP (manufacturer's suggested retail price) that the customer can expect to save based on standard published pricing. In a typical commercial embodiment, the “guaranteed price” would reflect a price at or below dealer invoice, which is a published, readily available number. Alternatively, the “guaranteed price” could reflect a price that is at least approximately 5% below MSRP. In an alternative embodiment, the “guaranteed price” could reflect a price that is at least approximately 10% below the MSRP. Still alternatively, the “guaranteed price” could reflect a price that is at least approximately 1% below dealer invoice. Those skilled in the art will understand that the “guaranteed price” can be any preset amount or percentage of a fixed price. If the customer does not receive bids that save him or her at least as much as the system's “guaranteed price,” then the server 12 prompts the customer to select from a refund or starting another auction at step 408. The server 12 makes a determination at step 410 if it received a selection to start a new auction. If the server 12 determines that a new auction is selected, the post auction process 400 ends and the server 12 goes to step 202 (of FIG. 4A). If, however, the server 12 determines that a new auction was not selected and a refund has been selected, the server processes the refund request at step 412, and the process 400 ends. However, if at step 414, the server 12 determines that the bids were lower than the “guaranteed price,” the server does not refund the auction fee at step 416 and the process 400 ends.

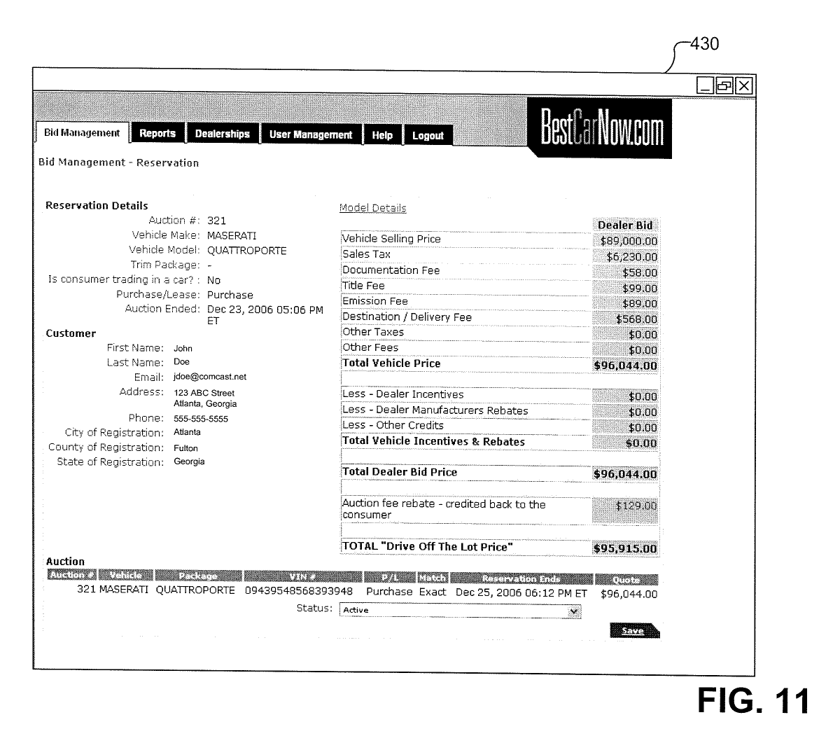

Referring back to the determination made at step 404, if the server 12 determines that it received an acceptance of a bid, the method 400 proceeds to step 418 and prompts the customer to enter personal information, such as his or her full name, home address, phone number, etc. Optionally, the server 12 can prompt the customer to input how he or she will pay for the vehicle, such as with a check or credit card. Once the server 12 receives the customer's personal information, the server displays the reservation information to the customer, including the contact information of the winning dealership and the transaction information at step 420. The server 12 can display to the customer the final details of the deal, including the sales price, dealer address, vehicle specifications (including VIN), and the timeline for pickup at step 422. An exemplary screenshot 430 of a reservation page is depicted in FIG. 11, which shows the details of the transaction. Also, the server 12 can display to the customer a reminder that the dealer will refund the auction reservation fee upon completion of the purchase. Preferably, the server 12 sends the winning dealer a congratulatory email and sends the losing bidders a notice that their bids were not accepted. If the customer does not take delivery of the vehicle within the certain amount of time, the bid is voided and the customer forfeits his or her auction fee. The process 400 ends.

Preferably, the system 10 further includes a dealer-rating system that the customers use to rate their experience and that future customers can use in deciding which bid to accept. Such dealer-ratings are published both to the dealers and to future customers.

Furthermore, it should be understood by those skilled in the art that the present invention also includes administrative privileges for the administrator(s) of the system 10. For example, the administrator can access and update information on its customers and on its dealers.

In an alternative embodiment, the server 12 can prompt the customer to submit a reservation fee (e.g., a refundable deposit), in lieu of the auction fee, after the server electronically communicates all bids and revised bids to the customer. This reservation fee would serve to guarantee the customer's commitment to purchase the vehicle after he accepts a desired bid. If the savings provided by one of the bids is attractive, the customer will likely be interested in proceeding. At this point, the server 12 would prompt the customer to input his payment information, such as his credit card information or his bank account information. Typically, this reservation fee would be in lieu of the reverse auction fee, although it can be in addition to the auction fee. The server 12 would not refund the reservation fee or credited to the customer's account unless he or she completes a transaction with one of the bidding dealers.

Accordingly, the present invention provides a number of advantages over existing methods of buying and selling vehicles. For example, customers who buy vehicles in accordance with the present invention can enjoy the benefits of a non-traditional, no-hassle way to buy a vehicle; receiving the best price on the vehicle wanted by an auction process in which multiple dealers actually bid against each other; purchasing a vehicle without dealing with a pressuring salesman; shopping more effectively by quickly comparing prices from multiple dealers, with the option to pick between competing offers from dealers; and paying nothing for the service. Dealers too enjoy several benefits, including expanded sales channels and access to qualified buyers; reducing the cost of sales by reducing overall advertising expenses and by eliminating salesmen commissions for sales made through the auction process; reducing expenses by not chasing non-qualified shoppers; paying nothing to participate in the auction process; and leveraging the dealer's existing Internet sales program; and receiving feedback for evaluating the effectiveness of its dealer pricing practices.

It is to be understood that this invention is not limited to the specific devices, methods, conditions, or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “one” include the plural, and reference to a particular numerical value includes at least that particular value, unless the context clearly dictates otherwise. Ranges may be expressed herein as from “about” one particular value and/or to “about” another particular value. When such a range is expressed, another embodiment includes from the one particular value and/or to the other particular value. Similarly, when values are expressed as approximations, by use of the antecedent “about,” it will be understood that the particular value forms another embodiment.

While the invention has been described with reference to preferred and example embodiments, it will be understood by those skilled in the art that a variety of modifications, additions and deletions are within the scope of the invention, as defined by the following claims.

What is claimed is:

1. A system for vehicle transactions between a customer and a plurality of dealers, comprising:
a server connected to a communications network and having access to a vehicle specifications database, the server hosting a website that is accessible by a network-connected user device of the customer and network-connected user devices of the plurality of dealers, the website providing for a reverse auction, wherein the system receives a request from the customer via the website for a bid for a specified vehicle; communicates the bid request to each of the plurality of dealers; receives bids from the plurality of dealers; communicates all of the dealer bids to the customer and to each of the plurality of dealers; receives revised bids from the plurality of dealers; and receives from the customer a selection of one of the bids or revised bids from one of the plurality of dealers.

2. The system of claim 1, wherein the server further hosts a separate account for each of the plurality of dealers.

3. The system of claim 2, wherein the server displays a dedicated webpage to each dealer for viewing bids by other dealers in pending reverse auctions and for inputting initial bids and revising current bids.

4. The system of claim 1, wherein the server further hosts a separate account for each customer.

5. The system of claim 4, wherein the server displays a dedicated webpage to the customer for viewing bids and revised bids.

6. The system of claim 1, wherein the vehicle specifications database is updated when new vehicles or options become available.

7. A method of transacting vehicles between a customer and a plurality of dealers, comprising:
receiving a request from the customer for a bid for a specified vehicle;
communicating the bid request to each of the plurality of dealers;
receiving bids from the plurality of dealers;
communicating all of the dealer bids to the customer and to each of the plurality of dealers;
receiving revised bids from the plurality of dealers; and
receiving from the customer a selection of one of the bids or revised bids from one of plurality of dealers.

8. The method of claim 7, further comprising sending bid requests to a supplemental plurality of dealers if a predetermined number of bids is not received within a predetermined amount of time.

9. The method of claim 8, wherein the predetermined amount of time is selected to be in the range of approximately twelve to approximately thirty-six hours after the bid request is sent.

10. The method of claim 7, wherein the step of communicating the bid request includes withholding the identification of the customer.

11. The method of claim 7, wherein the step of communicating all of the dealer bids to the customer and to each of the plurality of dealers includes withholding the identity of each of the dealers.

12. The method of claim 7, further comprising the step of receiving a predetermined payment from the customer prior to communicating the customer bid request to the plurality of dealers.

13. The method of claim 7, wherein the step of receiving a customer's request further includes receiving a list of desired options.

14. The method of claim 13, wherein the step of receiving bids from the plurality of dealers includes receiving bids for a vehicle that matches the vehicle specification.

15. The method of claim 14, wherein the step of receiving bids from the plurality of dealers includes receiving bids for a vehicle that does not match but is similar to the vehicle specification.

16. The method of claim 7, wherein the step of communicating the customer's bid request to the plurality of bidders further includes communicating the customer's request to bidders located with a predefined area around the customer.

17. The method of claim 7, further comprising electronically communicating a message to one of the dealers when it has been outbid.

18. The method of claim 7, wherein each received bid includes ails fees and taxes the customer is expected to pay.

19. A method of conducting a reverse auction for a purchaser of a motorized vehicle, comprising:
electronically requesting bids from a plurality of bidders for a desired vehicle;
electronically receiving bids from the plurality of bidders; and
electronically publishing all received bids to all bidders via a website.

20. The method of claim 19, further comprising:
electronically communicating a message to a first bidder that it has been outbid by a second bidder.

21. The method of claim 20, further comprising receiving a revised bid from the first bidder.

22. The method of claim 19, further comprising electronically communicating to all bidders all received bids as they are received.

23. The method of claim 19, further comprising prompting the purchaser to accept a bid.

24. The method of claim 19, further comprising inviting additional bidders to the reverse auction if a predetermined number of bids have not been received after a predetermined period of time.

25. The method of claim 18, wherein the step of electronically receiving bids further includes electronically receiving bids for vehicles similar to the desired vehicle.

26. A computer-readable medium storing instructions that, when executed on a programmed processor, carry out a method for a reverse auction for a vehicle, comprising:
instructions for processing a request for bids for a specified;
instructions for soliciting bids from a plurality of bidders for the specified vehicle;
instructions for receiving bids from the plurality of bidders;
instructions for receiving revised bids from the plurality of bidders; and
instructions for publishing all received bids to all bidders via a website.

27. The computer-readable medium of claim 26, further comprising instructions for processing an acceptance of a bid.

28. The computer-readable medium of claim 26, further comprising instructions for filtering frivolous requests by requiring an auction fee payment prior to soliciting bids from the plurality of bidders.
